(19) United States
(12) Patent Application Publication
(10) Pub. No.: US 2008/0306619 A1
(43) Pub. Date: Dec. 11, 2008

(54) Systems And Methods For Synchronizing Music

(75) Inventors: Joseph P. Cerra, Pawling, NY (US); Michael P. Visconti, III, Milford, MA (US)

Correspondence Address: Casimir Jones, S.C., 440 Science Drive, Suite 203, Madison, WI, 53711, US

(73) Assignee: Tufts University, Boston, MA (US)

(21) Appl. No.: 11/994,450

(22) PCT Filed: Jun. 29, 2006
(86) PCT No.: PCT/US06/25613

§ 371 Date: Jun. 18, 2008

Related U.S. Application Data
(60) Provisional application No. 60/696,218, filed on Jul. 1, 2005.

(51) Int. Cl. G06F 17/00

(52) U.S. Cl. 700/94

(57) ABSTRACT

The present invention relates to music systems. In particular, the present invention relates to music systems capable of altering the rate of play (e.g., beats per time interval) of a musical piece such that it matches a user's rate of movement per time interval.

### FIELD OF THE INVENTION

The present invention relates to music systems. In particular, the present invention relates to music systems capable of altering the rate of play (e.g., beats per time interval) of a musical piece such that it matches a user's rate of movement per time interval.

### BACKGROUND

Portable sound systems are popular within the physical exercising community. A tendency for exercisers is to listen to music that “fits” their workout pace while exercising. However, a limitation of portable sound systems is that the pacing of a particular song and the pacing of the user is not synchronous. What are needed are improved sound systems that operate in unison with the rate of movement of a user.

### SUMMARY

The present invention relates to music systems. In particular, the present invention relates to music systems capable of altering the rate of play (e.g., beats per time interval) of a musical piece such that it matches a user's rate of movement per time interval, for example, with little to no distortion of pitch or tonal quality, as well as providing the capability to change tempo as rate of movement changes. For example, the systems and methods of the present invention permit a user to synchronize their stride (or other body movement) to a song's beat (or other audio feature).

In certain embodiments, the present invention provides a device configured to alter the rate of play (e.g., beats per time interval) of an audio signal such that the rate matches a user's rate of movement per time interval. In preferred embodiments, the audio signal is a musical piece. In preferred embodiments, the audio signal is simultaneously represented while altering the rate of beats per minute in such a manner that there is little to no distortion of pitch or tonal quality. For example, in some embodiments, the distortion in pitch is less than a 10% change (e.g., in Hz) as compared to the unaltered source audio (e.g., less than 5%, 2%, 1%, 0.5%, 0.1%, . . . ). Preferably, any change in pitch is not detectable by the human ear. In some embodiments, total harmonic distortion (THD) added by the process is less than 2% (e.g., less than 1%, 0.5%, 0.2%).

In preferred embodiments, the user's rate of movement is measured with any device that senses and detects a user's rate of motion per time interval. In preferred embodiments, the user's rate of movement is measured with a pedometer. In preferred embodiments, the pedometer and the device communicate via wireless communication. However, the present invention is not limited by the nature of the body movement monitored or by the system or device for monitoring the movement. In some embodiments, the rate of play (e.g., beats per time interval) of the music is synchronized to other biological characteristics, including, but not limited to, heart rate.

In preferred embodiments, a beat detection algorithm detects the rate of beats per time interval for the audio signal. In other preferred embodiments, the rate of beats per time interval measured with the beat detection algorithm is altered to match the user's rate of movement per time interval with a phase vocoding algorithm.

In preferred embodiments, the user's rate of movement per time interval fluctuates. In other preferred embodiments, the time interval is a minute, although the interval can be longer or shorter (e.g., one second) or continuous.

In preferred embodiments, the device further comprises a graphical user interface configured to display information regarding the audio signal.

In preferred embodiments, the device is integrated within, for example, a treadmill, a portable music player, a bicycle, a disk jockey system, a stair climber, cardio-machines, gyms, athletic clubs, and athletic gear.

In certain embodiments, the present invention provides a system comprising an audio signal library comprising a plurality of audio signals, the audio signal library configured for selection of an audio signal; a beat detection algorithm configured to measure rate of beats per time interval for the audio signal; a phase vocoding algorithm configured to alter the rate of beats per time interval of the identifiable audio signal so that it matches a user's rate of movement per time interval; and a device for representing the altered audio signal. In preferred embodiments, the system instantaneously matches the beat of an audio signal with the user's rate of movement.

In preferred embodiments, the audio signal library is a musical piece library. In other preferred embodiments, the identifiable audio signal is a musical piece. In yet other preferred embodiments, the audio signal is simultaneously represented while altering the rate of beats per minute.

In preferred embodiments, the user's rate of movement is measured with any device that senses and detects a user's rate of motion per time interval. In preferred embodiments, the user's rate of movement is measured with a pedometer. In preferred embodiments, the pedometer and the phase vocoding algorithm communicate via wireless communication.

In certain embodiments, the present invention provides a method of synchronizing an audio signal with a user's movement, comprising providing i) an audio signal; ii) a device configured to alter the rate of the audio signal such that the rate matches a user's rate of movement per time interval; and iii) a movement detector configured to detect a user's rate of movement per time interval; detecting the user's rate of movement per time interval; and generating an altered audio signal such that the rate of the audio signal matches the user's rate of movement per time interval. In preferred embodiments, the method further comprises the step of representing the altered audio signal. In preferred embodiments, the altered audio signal is represented in such a manner that there is little to no distortion of pitch or tonal quality.

In certain embodiments, the present invention provides a system comprising a multitude of user's each using a movement detector configured to detect each user's rate of movement per time interval; a device configured to monitor the user rate of movements per time interval, and further configured to alter the rate of an audio signal such that the rate matches the user rate of movement per time interval. In preferred embodiments, the device alters the rate of an audio signal such that the rate matches, for example, the average rate of movement per time interval for the users, the fastest rate of movement per time interval for the users, the slowest rate of movement per time interval for the users, a leader's rate of movement per time interval, or any other variable relating to the rate of movement per time interval for the users. In preferred embodiments, the system is configured to provide each user a specific audio signal feed depending upon that user's rate of movement.

In certain embodiments, the present invention provides a device configured to alter the playback of musical beats for an audio signal such that the beats match a user's movement, wherein the device comprises a beat detection algorithm that detects each beat in the audio signal and records the beat in a data file. In some embodiments, the device further comprises a playback algorithm that coordinates the beat with the time of the movement. In some embodiments, the user's movement is measured with a pedometer. In some embodiments, the pedometer and the device communicate via wireless communication. In some embodiments, the device is configured to continuously alter the playback of the musical beats for the audio signal. In some embodiments, the device further comprises a graphical user interface configured to display information regarding the audio signal. In some embodiments, the playback is halted upon the ceasing of the user's movement.

In some embodiments, the device further comprises an algorithm that stretches or shrinks audio between the beats so as to provide a smooth transition between the movements. In some embodiments, the smooth transition avoids skipping or overlapping of the audio between the beats.

In certain embodiments, the present invention provides a system configured to alter the rate of beats per time interval for an audio signal such that the rate matches a plurality of users' rate of movement per time interval. In some embodiments, the rate of movement per time interval comprises an average rate of movement of each of the plurality of users.

In certain embodiments, the present invention provides a system configured to select and provide audio to match a predetermined body movement rate to define an exercise interval, the system comprising a processor configured to: a) receive an exercise interval input; b) receive a body movement rate input; c) select an audio file from a library of audio files wherein the selected audio file has a duration that approximates the exercise interval; d) modifies the beat of the audio file to match the body movement rate; and e) modifies the duration of the audio file, if necessary, to match the interval input. In some embodiments, the exercise interval comprises a running or walking distance and wherein the body movement rate comprises footstep rate.

### DEFINITIONS

To facilitate an understanding of the present invention, a number of terms and phrases are defined below:

As used herein the terms “processor,” “digital signal processor,” “DSP,” “central processing unit” or “CPU” are used interchangeably and refer to a device that is able to read a program (e.g., algorithm) and perform a set of steps according to the program.

As used herein, the term “algorithm” refers to a procedure devised to perform a function.

As used herein, the term “tempo” refers to the rate of speed at which an audio signal is performed.

As used herein, the term “audio signal” refers to any kind of audible noise, including, but not limited to musical pieces, speeches, and natural sounds.

As used herein, the term “user” refers to any kind of mammal (e.g., human, dog, cat, mouse, cow, etc.).

As used herein, the term “movement” refers to any kind of repeating function that is detectable. Examples of movement include, but are not limited to, heart beats, pulse, leg movements, arm movements, head movements, breathing related movements, hand movements, hip movements, and foot movements.

As used herein, the term “per time interval” refers to any increment of time (e.g., milliseconds, seconds, minutes, hours, days, months).

As used herein, the term “movement detector” refers to any apparatus capable of detecting a rate of movement per time interval (e.g., pedometer).

As used herein, the term “audio player” refers to any kind of device or system capable of presenting (e.g., playing) an audio signal. Examples of audio players include, but are not limited to, I-Pods, mini-disc players, mp3 players, walkmans, and digital audio players.

As used herein, the term “wave file,” “waveform audio files,” or “.wav file” refers to digital audio signals. Wave files are a standard for uncompressed audio data on computer systems. Audio data from Compact Discs and Digital Video Discs are easily “ripped” into wave files, and wave files are easily encoded into alternative formats (e.g., shn, flac, MP3).

### DETAILED DESCRIPTION

The music systems of the present invention are applicable for altering the speed of an audio file such that it is synchronous with a user's rate of movement, and such that there is little or no distortion of pitch or tonal quality of the audio file. In preferred embodiments, the present invention provides playback speed adaptive audio players configured to measure a user's rate of movement (e.g., leg strides, arm swings, head movement, hand movement, foot movement, clothing movement, etc.) and alter the tempo (e.g., beats per minute) of a musical or audio piece such that the musical piece is presented at a playback rate synchronous or otherwise correlated with the user's rate of movement (described in more detail below). In preferred embodiments, the musical or audio piece is altered such that there is little or no distortion of pitch or tonal quality. The use of audio players (e.g., I-Pods, mini-disc players, mp3 players, walkmans, digital audio players) is a standard for exercising individuals. The music systems of the present invention provide numerous advantages over prior art audio players including, but not limited to, the ability to alter the timing of a musical piece in timing with a user's rate of movement. In some preferred embodiments, the music systems function on the principle that the playback speed of a song is altered with beat detection and phase vocoder algorithms and presented in time with a user's rate of movement (described in more detail below). The Detailed Description and Examples sections illustrate various preferred embodiments of the music systems of the present invention. The present invention is not limited to these particular embodiments.

In particularly preferred embodiments, the music systems of the present invention are used to enhance a user's exercise regime. The psychophysiology of the Acoustic Startle Reflex (ASR) has been studied for decades in humans and animals. Viewed as primarily a survival mechanism of alarm, the ASR sends a nerve impulse down the spinal cord, arousing any human that perceives a loud noise. The beat of a song can correspond to an ASR inducer. Inducing the ASR through a musicial stimulus serves to benefit the efficiency of a user's workout. For example, when one synchronizes a voluntary motion with the beat of a song, a more even distribution of force on the muscle joints is produced. This in turn makes the joints more stable during physical activity, which helps to strengthen joint muscles in the long run. Thus, a jogger or exerciser who uses this music system physically benefits from a more efficient, smoother, and safer workout. The system also has aesthetic advantages in that users often prefer to coordinate body movement to music for other psychological reasons.

Exemplary systems and methods of the present invention are described in more detail in the following sections: I. Altering the Playback Speed of an Audio File; II. Beat Detection; III. User Interface; IV. Audio Files; V. User Movement Detection; and VI. Physical Implementation of the Music Systems.

### I. Altering the Playback Speed of an Audio File

Increasing or decreasing a digital musical piece's playback speed (e.g., sample rate) correspondingly alters the pitch of the musical piece. In preferred embodiments, the playback speed of an audio file is altered so as to be in synch with, for example, a user's rate of movement. The present invention is not limited to a particular method or product for altering the playback speed of an audio file (e.g., phase vocoding software; Dolphin Music—ReCycle 2.1; Roland VP-9000 VariPhrase Processor; Max/MSP from Cycling 74; Live, MIDIGrid, and Rebirth from The Drake Music Project; see, generally, e.g., U.S. Pat. No. 4,542,674; David Dorran and Robert Lawler, “An efficient phasiness reduction technique for moderate audio time-scale modification,” Proc. of the 7^{th} Intl. Conference on Digital Audio Effects (DAFX'04), Naples, Italy, Oct. 5-8, 2004; Axel Robel, “A new approach to transient processing in the phase vocoder,” Proc. of the 6th Int. Conference on Digital Audio Effects (DAFx-03), London, UK, Sep. 8-11, 2003; Florian Hammer, “Time-scale Modification using the Phase Vocoder: An approach based on deterministic/stochastic component separation in frequency domain,” Diploma Thesis submitted to Institute for Electronic Music and Acoustics (IEM), Graz University of Music and Dramatic Arts, A-8010 Graz, Austria, Graz, September 2001; and Jean Laroche and Mark Dolson, “New Phase-vocoder techniques for pitch-shifting, harmonizing and other exotic effects,” Proc. 1999 IEEE Workshop on Applications of Signal Processing to Audio and Acoustics, New Paltz, N.Y., Oct. 17-20, 1999; each herein incorporated by reference in their entireties).

In preferred embodiments, the musical systems of the present invention comprise phase vocoding technology so as to dynamically stretch or shrink the length of digital audio track while keeping the pitch intact. The present invention is not limited to a particular type of phase vocoding technology (see, e.g., U.S. Pat. Nos. 6,868,377, and 6,549,884, each herein incorporated by reference in their entireties).

The present invention provides a phase vocoding algorithm for transforming a digital musical piece (e.g., song or segment of a song) based on its frequency content over time (e.g., to alter a song's playback speed without affecting the song's pitch, and visa versa). The inputs to the phase vocoding algorithm are the Pulse Code Modulation (hereinafter, “PCM”) samples of an audio song along with a stretch/shrink coefficient and sample rate. Certain parameters internal to the algorithm are specified to fine tune the performance and time delay of the process. The phase vocoding algorithm produces a new set of PCM samples representing the modified sound along with an integer value representing the new number of samples.

In preferred embodiments, the phase vocoder algorithm coordinates the tempo (e.g., beats per minute) of a musical piece with the rate of movement of a user (described in more detail below).

### II. Beat Detection

Virtually every musical piece has a fixed number of beats for a given amount of time. Beats are usually uniform in spacing and occur at a constant rate throughout a song. The human listening system determines the rhythm of a song by detecting a periodical succession of beats. The signal intercepted by the ear contains certain amounts of energy. The brain senses changes in the amount of energy it receives throughout a song's playback and interprets these changes as beats to the song.

The beats in a song can be captured in many ways depending on what type of song is being played (e.g., rock and roll, techno, hip-hop, or country). In preferred embodiments, the musical systems of the present invention comprise beat detection algorithms for assessing the beat patterns within a musical piece. The present invention is not limited to particular types of beat detection algorithms. Fourier transforms, convolutions, correlations and statistical variances may all be used in beat detection algorithms to distinguish beats in different forms of music (see, e.g., Krishna Garg, H., et al., (1998) Digital Signal Processing Algorithms: Number Theory, Convolution, Fast Fourier Transforms, and Applications, published by CRC Press; herein incorporated by reference in its entirety).

In preferred embodiments, the beat detection algorithms of the present invention compute the average amount of energy in a song and compare it with the energy found in each fractional-second segment of the song so as to locate areas of high energy (e.g., beats).

In preferred embodiments, the beat detection algorithms of the present invention are designed to interpret energy changes in both the frequency and the time domains of a signal throughout its duration, thereby capturing each beat of a song. Upon detection of all of the beats of a song, the original music file is split up into separate segments corresponding to one beat. The beat detection algorithm requires, as inputs, the PCM samples of the input song as well as its sample rate. The output of the beat detection algorithm is a data file indicating the file positions of each beat in the song.

In preferred embodiments, the music systems utilize a user interface to select musical pieces to upload to the portable music player (e.g., iTunes, Windows Media Player, a compact disc). In preferred embodiments, the user interface detects all the sounds that may be used to represent a beat and allow the user to select the sound of the beat they prefer (e.g., snare beats, kick drum beats, back beats, vocal beats) and/or the tempo they prefer. In yet other preferred embodiments, the music system differentiates the various types of beats by filtering out certain frequencies.

In preferred embodiments, upon selection of a desired type of beat, the beat detection algorithm locates all of the beats in a selected musical piece and stores the resulting information. This information contains the instances of each beat in a musical piece, as well as the beats per minute of the song. In some preferred embodiments, the relevant beat detection information is either written to separate files and accompany the audio files, or is written directly in the audio files' headers.

In preferred embodiments, the information obtained with the beat detection algorithm is used later by the phase vocoder algorithm to dynamically link the BPM of the song to the SPM of the user (described in more detail below).

### III. User Interface

In preferred embodiments, the musical systems of the present invention comprise a user interface. The user interface combines the phase vocoding algorithm and beat detection algorithm. In preferred embodiments, the user interface supports the waveform audio format (e.g., *.wav). However any format may be used (e.g., mp3, .aiff, .shn, .flac, .ape). In preferred embodiments, the user interface allows a user to select wave audio files from, for example, a computer hard drive or compact disc, and perform time stretching and shrinking.

In preferred embodiments, the user interface is a graphical user interface. In preferred embodiments, the graphical user interface provides numerous control elements for a user. For example, in preferred embodiments, the graphical user interface provides a slider control for simulating the rate of movement of a user (e.g., an exercising user). In addition, preferred embodiments of the graphical user interface provide speedometer animation for depicting the speed of a user. Additionally, the graphical user interface further provides a text box for displaying verbose output from the phase vocoding and beat detection algorithms and the file I/O processes. In yet other preferred embodiments, the graphical user interface provides an “about” box for copyright information and crediting sources. Additionally, the graphical user interface is capable of launching web browsers for accessing information or data from a particular web site. In further preferred embodiments, the graphical user interface provides an options dialog for the purpose of fine tuning algorithm timing.

The present invention is not limited to a particular type of user interface. In some embodiments, the design of the user interface is in the form of a Microsoft Foundation Classes (hereinafter, “MFC”)-based Windows graphical user interface.

### IV. Audio Files

The primary input for the user interface is an audio file. The present invention is not limited to a particular type of audio file (e.g., mp3, .aiff, .wav, .shn, .flac, .ape). In preferred embodiments, the present invention uses standard waveform audio files (e.g., Resource Interchange File Format (hereinafter, “RIFF”) WAVE files).

In some embodiments, the music systems of the present invention support audio files encoded at 8 or 16-bits per sample in an uncompressed, mono PCM format. In preferred embodiments, the music systems of the present invention provide a sound recorder application for converting any wave file to an 8 or 16-bits per sample uncompressed, mono PCM format. In preferred embodiments, the music systems of the present invention support audio files encoded at any bit rate (e.g., 256 bits per sample) and stereo or surround sound formats.

In preferred embodiments, the user interface parses the header of an audio file for relevant format information, and error messages are displayed when an invalid file type is chosen. In preferred embodiments, temporary output wave files are generated by the phase vocoding and beat detection algorithms for each beat of the input file and are used during audio playback. In preferred embodiments, the temporary files are subsequently deleted by the user interface.

In some embodiments, the music systems of the present invention provide a sound recorder application including a codec allowing MP3 compression of audio files. In additional embodiments, the music systems of the present invention include robust waveform audio file support providing functionality for converting formats of wave files. For example, in some embodiments, a built-in conversion mechanism internal to the application is provided. Additionally, in some embodiments, the music systems of the present invention, the sound recorder application is used as an external addition using, for example, a ShellExecute command.

### V. User Movement Measurement

In preferred embodiments, the musical systems of the present invention detect the rate of external motion for a user and accordingly alter the playback rate of a musical piece. The present invention is not limited to a particular method for detecting the rate of movement for a user. Additionally, the present invention is not limited to detecting a particular type of movement (e.g., leg strides, arm movements, jumping). In some embodiments, the musical systems are configured such that the playback of the device is halted upon the stopping of a user's movement, and restarted upon the restarting of the user's movement.

In preferred embodiments, the music systems of the present invention provide a pedometer for detecting the rate of movement for a user. For example, a pedometer attaches to a user's waist, counts each step the user makes, and provides input data to the phase vocoding algorithm.

In preferred embodiments, the music systems of the present invention include a wireless technology (e.g., Bluetooth wireless technology) for determining a user's rate of movement as opposed to a pedometer. Bluetooth wireless technology, for example, allows for motion detection and motion sensing.

In preferred embodiments, any existing digital music player, including but not limited to Apple products, Sony products, Creative products, or Samsung products, may be outfitted with an internal or external pedometer and the necessary firmware/hardware required for performing the phase vocoding and beat detection algorithms. In other preferred embodiments, a pedometer is replaced or augmented with any other type of motion sensing device (e.g., an internal pendulum type device).

In preferred embodiments, the music systems of the present invention are not necessarily limited to detecting a user's rate of movement. In some embodiments, the music systems of the present invention are configured to detect any item's rate of movement (e.g., a pendulum's rate of movement, a third person's rate of movement, etc.).

### VI. Physical Implementations of the Music Systems

The music systems of the present invention are not limited to particular physical implementations. In preferred embodiments, the music systems of the present invention detect each beat in a song, and record it in a temporary data file on the player. Each step or motion by the user triggers an electronic signal via the pedometer or other measuring device. Each beat of the song is then coordinated to occur at the exact time of a user's movements (e.g., steps). The phase vocoding algorithm is then used to stretch or shrink the music between beats so as to provide a smooth transition between movements (e.g., with no skipping or overlap). In preferred embodiments, the end result is a method of dynamically altering a musical piece's tempo in unison with a user's detected rate of movement and seamlessly synchronizing each beat of the musical piece with the user's movements.

In preferred embodiments, a rechargeable battery setup is linked to a small, custom PCB. In preferred embodiments, the music systems include a package including a compact, durable case tailored for the rigors of daily exercise. In preferred embodiments, the PCB includes a solid state memory for storing audio data, along with a Digital Signal Processor (hereinafter, “DSP”) for processing the data and executing the beat detection and phase vocoding algorithms. In preferred embodiments, the music systems of the present invention include an LCD display with simple buttons as a user interface for selecting audio files and displaying a user's speed. In yet other preferred embodiments, the music systems of the present invention include a small amplified headphone jack for driving the audio output devices. In preferred embodiments, a user's rate of movement is inputted either from a pedometer built into the music player or wirelessly from a separate unit (described in more detail below).

In preferred embodiments, the music systems of the present invention allow a user to manually set a playback tempo. For example, the manual setting of a playback is used to help a user maintain a certain pace or listen to a musical piece at a preferred speed. In further embodiments, the music systems are equipped to search a music library and play only musical pieces with a tempo equivalent to a desired rate of movement (e.g., strides per minute of a 10 mph running speed). In some such embodiments, musical pieces close to a desired tempo are stretched or shrinked to match the desired pace. In additional embodiments, a desired distance may be selected (e.g., 5 miles) and the music system accordingly selects musical pieces from a musical library in accordance with the user's speed such that, for example, the play list completes when the user has moved the desired distance. In some embodiments, tempo is selected to accompany a pre-programmed exercise routing on a treadmill, stationary bike, stairclimber, etc. In such embodiments, the sound of music helps cue the user to increase physical movement at a rate optimized for a portion of a variable pre-programmed routine.

In preferred embodiments, the music systems of the present invention find use in the design of Disc Jockey (DJ) equipment (e.g., Gemini DJ products, Stanton DJ products, Peavey DJ products). Software implementations of the design may be used by a DJ to speed up and slow down musical pieces being played back to achieve a unique audio effect. These features can be incorporated into an ordinary PC or into existing DJ equipment (e.g., a standalone, component-type, or rack-mount piece of hardware that interfaces with amplifiers or DJ equipment). In preferred embodiments, the members of a DJ's audience are outfitted with a motion measuring device such as a pedometer or a vibration sensor that communicates wirelessly to the DJ's equipment thereby allowing the DJ to synchronize the music being played with the speed at which the audience is dancing. In preferred embodiments, a DJ is outfitted with movement sensors that allow creating audio effects not by touching any equipment but rather by the DJ's personal movements.

In preferred embodiments, the music systems of the present invention find use within exercise equipment (e.g., Bowflex products, Ab-Roller products, treadmills, stair masters, cardio machines, etc.). In such embodiments, the technologies encompassed by the music systems of the present invention are integrated into exercise equipment such that repetitions on the gym equipment are detected. For example, the pedals or belts on a machine sense a user's movements and the system's processing hardware and speakers are built-into the control panel of the exercise equipment.

In preferred embodiments, the music systems of the present invention find use within gyms and/or athletic clubs. For example, customers at a gym and/or athletic club carry a single portable music player, which interfaces wirelessly with sensors on each used machine so as to obtain user movement inputs (e.g., by simply bringing the music systems of the present invention in proximity with a leg press machine, the machine would communicate wirelessly to the musical system the frequency of the user's leg press repetitions, and accordingly adjust playback speed). In additional preferred embodiments, wireless motion detectors are used to communicate to a base station (e.g., a club's front desk) so as to generate a statistical average of the average workout pace of each person in the club at a particular time thereby allowing the music system to provide appropriately timed musical pieces.

In preferred embodiments, the music systems of the present invention find use within athletic wear and/or footwear manufacturers (e.g., Nike products, Saucony products, Adidas products). For example, shoe manufacturers may integrate a pedometer or other wireless motion sensor into the soles of the shoe such that the musical system is programmed to read user movements from the sensors built into the user's shoes or other workout garments.

In preferred embodiments, the music systems of the present invention find use in any type of setting, including, but not limited to, dancing settings, swimming settings, acting settings, academic settings, camping settings, sleeping settings, transportation settings, and business settings.

### EXAMPLES

### Example I

This example describes a phase vocoding algorithm. A block diagram representation of a phase vocoding algorithm is shown below.

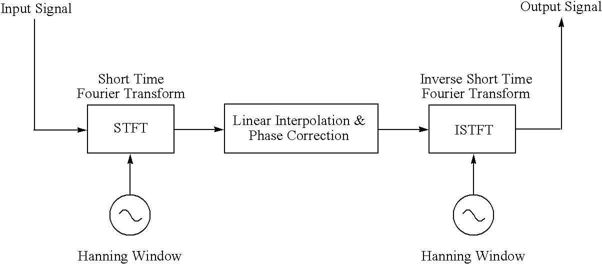

### Phase Vocoding Algorithm

### Initializations

Data structure loaded with audio, sample rate and number of samples.
Initialize variables (timescale, hopfactor, scale, hopsize, rows, cols)
Create Hanning window

hannwin[i]=(float)(0.5*(1−cos((2*pi*i)/hannlength)));

### Encode

Multiply input song by the Hanning window and store n-point FFT in encodedsong[ ]
Scale encodedsong as needed

### Interpolate

Compute the phase of the imaginary part of the encoded signal and store in variable PhaseX.
Copy into temporary variables X1 and X2 the rows of the encoded song by the columns of the floor of a variable used to offset X1 and X2.

for(j=0; j<rows; j++)
{

X1[j].real =

encodedsong[j][(int)(floor(k))+1].real;

X1[j].imag = encodedsong[j][(int)(floor(k))+1].imag;
X2[j].real = encodedsong[j][(int)(floor(k))+2].real;
X2[j].imag = encodedsong[j][(int)(floor(k))+2].imag;

}

Compute the sum of the magnitudes of X1 and X2 and store in variable Xmag.
Compute the interpolated signal Xint by multiplying Xmag by the cosine of PhaseX for the real part, and by multiplying Xmag by the sine of PhaseX for the imaginary part.
Compute the phase advance (or phase correction) by subtracting the imaginary part of X1 from the imaginary part of X2.
Compute the new phase which is PhaseX+phase advance.

### Decode

Perform the inverse FFT on the interpolated signal, Xint.
Multiply the interpolated signal by the Hanning window.
Copy the result of the inverse FFT and write to time-scaled .wav file.

### Example II

This example describes beat detection algorithms in some embodiments of the present invention.

### Simple Sound Energy Algorithm

### For Every 1024 Samples

Compute the instant sound energy, e, on the new 1024 samples taken from Left and Right Channels (for mono signal, use the same signal for left and right).

$$e = {e}_{right} + {e}_{left} = 2 {e}_{mono} = {\sum }_{n = {i}_{0}}^{{i}_{0} + 1024} {a [ n ]}^{2} + {b [ n ]}^{2}$$

Compute Average local energy, <E>, from local energy history buffer, E.

$$< E >= \frac{1}{43} \times {\sum }_{i = 1}^{43} ( {E [ i ]}^{2} )$$

Compute the variance, V, of the last 43 energies in E.

$$V = \frac{1}{43} \times {\sum }_{n = 1}^{43} {( E [ n ] - < E > )}^{2}$$

Compute constant, C, using linear regression from V.

C=(−0.0025714×V)+1.5142857
Shift E one index to the right; add newest energy value, e, and flush oldest e.
If e≧(C<E>) then beat detected.

### Frequency Selected Sound Energy Algorithm

### For Every 1024 Samples

Compute the FFT of the 1024 new samples for the left and right channels.

(aₙ)+i(bₙ)
Compute the magnitude of the FFT results and store in buffer, B[1024].
Divide the buffer into 64 sub bands. Compute the energy in each sub band and store it in Es[band] (Es[ ] should contain 64 elements).

$$Es [ i ] = \frac{32}{1024} \times {\sum }_{n = i \times 64}^{( i + 1 ) \times 64} B [ n ]$$

For each sub band corresponds an energy history buffer, Ei[43], which contains the last 43 energy values for the particular sub band. Compute the average energy for each sub band, <Ei>.

$$< Ei >= \frac{1}{43} \times {\sum }_{n = 1}^{43} Ei [ n ]$$

Shift Ei[43] buffer index to the right by one. Add the new energy value of the sub band and delete the oldest energy value.
Compute the variance of the history buffer for each sub band.

$$V ( Ei ) = \frac{1}{43} \times {\sum }_{n = 1}^{43} {( Ei [ n ] - < Ei > )}^{2}$$

For each sub band, if Es[i]≧(Cx<Ei>); and V(Ei)≧V₀ where V₀ is a constant value (usually about 150) then a beat was detected in that sub band.

### Derivation and Comb Filter BPM Detection Algorithm

Choose approximately 5 seconds of data in the middle of the song, noting the number of samples, N.

N≦5×Sample_Rate
Compute the FFT of the samples. Store the real part in TA[n] and the imaginary part in TB[n].
For all the BPM that will be tested (e.g., from 60 BPM to 180 BPM in steps of 2), note the current BPM being tested, BPMc.
   Compute a train of impulse offset value, Ti, corresponding to the BPMc.

$$Ti = \frac{60}{{BPM}_{tested}} \times fs$$

Compute the train of impulses signal and store it in two identical arrays, J and L using the following algorithm.

for (int k=0; k < N;k++)
{

| | |
|---|---|
| if (k%Ti == 0) | J[k] = L[k] = AmpMax; |
| else | J[k] = L[k] = 0; |

}

Compute the FFT of the complex signals J and L and store the result in TJ and TL.
Compute the energy of the correlation between the train of impulses and the 5 second signal.

$${E}_{{BPM}_{current}} = {\sum }_{n = 0}^{N} \vert ( TA [ n ] + i \times TB [ n ] ) \times ( TL [ n ] + i \times TJ [ n ] ) \vert$$

Store E(BPMc) in an array.
The BPM of the song is given where all the E(BPMc) reach a maximum.

### Example III

This example describes a phase vocoding algorithm used to encode input signals. The phase vocoding algorithm encoded an input signal such that it was broken up into bins of size N—a sampling size of 1024 was used in the design. Here N was the length of the Hann window and the FFT. Each bin contained N samples. These windows were multiplied by a Hann window of size N and transformed into the frequency domain using an STFT, or short time Fourier transform, resulting in N frequency steps.

$$\begin{matrix}( Hanning window calculation ) & \\ hann = \frac{1}{2} ( 1 - cos ( 2 π \frac{k}{N - 1} ) ) for k = 0 to N - 1 , & Equation 1\end{matrix}$$

The bin size was cut in half (N=N/2) considering that the Nyquist theorem states a sampling rate greater than or equal to twice the highest frequency component in the original signal. The next bin was similarly calculated, except that because the frequency content of the signal changed over time and previous frequency content influenced the latter frequencies, the bins overlapped each other. The beginning of the next N samples that are placed in the next bin should start at the beginning of the previous bin plus a hop size. The hop size used in this design was 75% of N, or 768.

Next, the signal resulting from the encoding process was interpolated and phase corrected. Time stretching of the signal required performance of a linear interpolation to get expected sample values lying between the actual sample values.

$$\begin{matrix}( \begin{matrix}linear interpolation example \\ of stretching x [ ] by a factor of 2\end{matrix} ) & \\ X [ 1 ] = x [ 1 ] , \\ X [ 2 ] = ( \frac{2}{3} ) x [ 1 ] + ( \frac{1}{3} ) x [ 2 ] , \\ X [ 3 ] = ( \frac{1}{3} ) x [ 1 ] + ( \frac{2}{3} ) x [ 2 ] , \\ X [ 4 ] = x [ 2 ] , & Equation 2\end{matrix}$$

To calculate the phase correction, the phase advance (e.g., the difference in phase of the next sample minus the current sample) and the previous calculated phase was summed. This quantity represented how the phase changed in successive bins, thereby allowing reconstruction of frequencies that lied between bins. Finally, the last step for interpolation was to take each sample and multiply it by the complex representation of the phase correction.

Xmag*e^{jθ} where θ is the phase correction
(Equation 3, Final Output from Interpolation)

Lastly, the signal resulting from the interpolation was decoded. Signal reconstruction began by performing an inverse STFT on the samples. The inverse transform takes the complex conjugate of the STFT in reverse order. Because the signal is back in the time domain, N was changed back into its original form (N=2N). The samples taken from the inverse STFT were then multiplied by the Hanning window again and the new phase vocoded signal was obtained.

### Example IV

This example describes beat detection algorithms. Three different beat detection algorithms were designed for the music player in this embodiment. The first algorithm, called Simple Sound Energy, was useful for musical pieces with an obvious and steady beat (e.g., techno and rap music). This algorithm detected instant sound energy and compared it to the average local energy of the audio signal. If the instant sound energy was much greater than the local average, then it was assumed that a beat was found.

A constant, C, was used to determine how much greater the instantaneous sound energy was than the local average to discern a beat. A desired value for C is approximately 1.2 to 1.5 times greater than the local average. In order to avoid guessing an exact value of C, the variance of the energies that comprise the local energy average was computed. This variance was then used to compute a linear regression of the constant C.

An additional designed beat detection algorithm is called Frequency Selected Sound Energy. This algorithm transformed the signal into the frequency domain and computed the Fourier representation of every N samples. The Fourier transform inherently converted the signal into N frequency steps. These frequency steps were next grouped into sub bands. These sub bands were used to represent sounds of each frequency. The following equation demonstrates the conversion from N frequency steps to actual frequencies in Hz.

$$\begin{matrix}( frequency conversion to Hz ) & \\ f = \frac{( N - i ) fe}{N} , & Equation 4\end{matrix}$$

In the above equation, f is the frequency in hertz, N is the number of points in the FFT, i is the index of the desired frequency to convert, and fe is the sample frequency of the audio file.

By taking the N point FFT of groups and samples and calculating their sub bands, energy variation in individual sub bands was compared to a local average energy history of surrounding sample groups. In this method, a snare hit and a cymbal hit were isolated from each other and detected accordingly since the snare and the cymbal sounds are of different frequencies.

The constant, C, that was used to determine how much greater the instant frequency selected sound energy was than the local average energy was also calculated using the variance of the local average energy history. Regardless of how C is calculated, since the frequencies are analyzed for drastic energy changes, C was much greater in value with this algorithm than with the simple sound energy algorithm.

An additional beat detection algorithm calculated the BPM rate of a song whereas the other beat detection algorithms found beat positions. This algorithm involves an intercorrelation of impulse trains with the sound signal. This algorithm correlated an impulse train that represents a BPM rate with a sample from the digital audio and extracted the best fit that most resembled the BPM of the digital audio.

The period of the impulse trains was computed in the following way for each BPM that was correlated with the audio signal. The variable, fs, represented the sample frequency (usually 44100 samples per second).

$$\begin{matrix}( period calculation for impulse trains ) & \\ Ti = \frac{60}{{BPM}_{tested}} \times fs , & Equation 5\end{matrix}$$

Once the period for the impulse train was calculated, the impulse was created, as shown below.

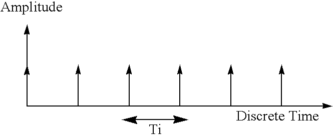

The correlation technique worked by comparing the energy of the correlation between the trains of impulses with the digital sound sample. The correlation with the signal and various BPM pulse trains that has the highest amount of energy represented the actual BPM of the song.

### Example V

This example describes a graphical user interface. The graphical user interface (GUI) was intended to provide an implementation of the playback speed adaptive music player. It was determined that important components for any implementation of the player were:
1) A means of expressing the user's rate of movement.
2) A means of portraying the speed to the user in a graphical format.
3) A system for reading in waveform audio files.
4) A process for executing the beat detection and phase vocoding algorithms on the input audio data.
5) A system for playing back the modified music file.

A Microsoft Windows based application was chosen for the GUI. A slider control was devised to represent the user's rate of movement. To simulate an increase in speed, a slider was moved to a higher position. In order to simulate a reduction in speed, the slider was moved to a lower position. The slider position was linked to a speedometer style animation in order to represent a user's simulated speed graphically to the user. Binary file I/O via the fread( ) and fwrite( ) C functions was used for handling the waveform audio files, and the C implementations of the two algorithms were integrated as subroutines in the GUI. The GUI used Microsoft's Multimedia Control Interface (hereinafter, “MCI”) multimedia handler to play the output audio on any machine's speakers or headphones.

### Example VI

This example describes a phase vocoding algorithm. MATLAB was used extensively as the platform for the development and testing of the phase vocoding algorithm. MATLAB provided an integrated development environment (IDE) with built in digital signal processing functions (e.g., Fourier transform and Hanning Window).

MATLAB was also used to input and output audio file data. Inherent in MATLAB's audio file I/O was a normalizing function that returned floating point values between the amplitudes of −1 and 1. This normalization was taken into consideration when developing a C/C++ program to read and write audio files.

The vocoding algorithm was developed in MATLAB. MATLAB's built-in wavread and wavwrite functions were also used to perform wave file input and output. After debugging and refining the MATLAB algorithm, the code was converted to C/C++ in a simple console application. The console based application still required the use of MATLAB's wavread function to generate a text file with American Standard Code for Information Interchange (hereinafter, “ASCII”) sample values for processing. In addition, MATLAB was still required to read in the ASCII output of the console program and convert it back to a wav file for playback. The following small MATLAB programs were written to perform these tasks:

%------------------------------------------------------------------%

| % | - WAV −> TEXT | % |
|---|---|---|
| % | | % |
| %Reads original sound, then writes it in text format | | % |
| %------------------------------------------------------------------% | | |
| %Reads in original wav file | | |
| y = wavread(‘ORIG.wav’); | | |
| %Prints its amplitude values to a text file | | |
| dlmwrite(‘data.txt’, y, ‘\n’); | | |
| %------------------------------------------------------------------% | | |
| %------------------------------------------------------------------% | | |
| % | - TEXT −> WAV | % |

| | |
|---|---|
| % | % |

%Reads original sound and stretched text file and plays both sounds%
%------------------------------------------------------------------%
%read original wav file
y = wavread(‘ORIG.wav’);
%read stretched text file
x = dlmread(‘out.txt’, ‘\n’);
%play both sounds
wavplay(y, 22050);
wavplay(x, 22050);
%------------------------------------------------------------------%

The integer values expressed indicate the number of milliseconds elapsed from the start of the algorithm's execution. The integer values were used in gauging the processing time and performance of the algorithm and fine-tune some of the algorithm's input parameters such as buffer sizes and Hanning window size.

Spreadsheet applications (e.g., Microsoft Excel) were also used frequently during the MATLAB to C++ conversion process to debug the algorithm. Enormous data sets can be compared quickly using macros in the spreadsheet application thereby reducing the development time and optimization of the algorithm.

The beat detection algorithm was developed mainly on a Linux box using a GNU C++ compiler. Variations of the wave file input and output functions used in the GUI were ported to the beat detection project. Extensive testing was performed on various types of input songs with each of the potential detection algorithms. After refining and debugging the algorithms, a version was chosen for the final design.

Microsoft's Visual C++5.0 and 6.0 were used as the development platform for the GUI. MFC was used extensively in designing the GUI and providing the skeleton for communication between its controls. The vocoding and beat detection algorithms were ported to Visual C++ as subroutines and tied into the wav file I/O functions. The end result was a seamless standalone application capable of performing all of the player's required functions.

### Example VII

This example describes the Integration of Sub-Components within a musical system. The four main sub-components of this project were integrated into a single, standalone windows application. The user interface provided a means of obtaining the target song's path and file name from the user, along with the user's rate of movement via a slider control. Upon selection of a target audio file, the waveform input functionality was used to read the wav file's format information, perform error checking, and load the audio samples, sample rate, and length of the file into a data structure. The beat detection algorithm was next executed on the audio samples and a data file was produced, marking the location in the wav file of each beat in the song. Playback began when the play option is selected (e.g., a user clicked the play button), after having loaded a song. The application used the windows MCI toolset to play the file back in a separate thread, simultaneously executing the phase vocoding algorithm on each segment of the song, delineated by the data file produced in the beat detection stage. Between each beat, the position of the GUI's slider control was sampled to determine a change in the user's speed. Upon a change in user movement, the phase vocoding algorithm's input argument was compensated accordingly and playback continued at a new rate. If no change was detected, playback continued at the last known rate. Each phase vocoded beat segment was written to a temporary output wav file. The number of temporary files varied as playback proceeded, but never exceeded five. Temporary files were written using the waveform output functionality, and were deleted upon exiting the program or opening a new file.

### Example VIII

This example describes a graphical user interface in one embodiment of the present invention. The graphical user interface was designed using Microsoft's Visual C++5.0 and 6.0. The skeleton of the application was constructed using Developer Studio's MFC AppWizard. This tool automatically generated the most basic code required for a dialog style window with basic controls.

Controls were added to the main dialog using Developer Studio's resource editor. A CFrame instance was inserted to contain the speedometer animation. A set of CButton instances were then inserted along with an instance of a CSliderCtrl and a CMenu. A pair of CEdit boxes were used for the status bar and the verbose console. The menu text and shortcut keys were also designed using the resource editor. The program contained two basic icons, 16×16 and 32×32 pixels for display in the title bar and about box. Finally, additional instances of CDialog were created for the “about” box and the “options” box. The dialogs were then filled with appropriate controls.

Once all controls were laid out on the dialog resources, Developer Studio's Class Wizard was used to create member variables for each control. Class Wizard also automated the process of writing function prototypes and function definitions for event handler member functions of each control. The snippets of code were then customized manually to achieve a desired operation.

### Example IX

This example describes initializing the main dialog. The following code was executed when the dialog was initialized:

//------------------------------------------------------------------------------------------
BOOL CVocoderDlg::OnInitDialog( )
{

| CDialog::OnInitDialog( ); | |
|---|---|
| SetIcon(m_hIcon, TRUE); | // Set big icon |
| SetIcon(m_hIcon, FALSE); | // Set small icon |

| //Set ranges and starting position for slider control | |
|---|---|
| m_speedslider.SetRange(75, 250, TRUE); | |
| m_speedslider.SetPos(100); | |
| m_playbutton.EnableWindow(FALSE); | |
| CMenu* mmenu = GetMenu( ); | |
| CMenu* submenu = mmenu−>GetSubMenu(0); | |
| submenu−>EnableMenuItem(ID_FILE_PLAY, MF_BYCOMMAND \| MF_DISABLED \| MF_GRAYED); | |
| verbose = TRUE; | |
| OnViewVerboseconsole( ); | //comment this line to make verbose the default |
| printheader( ); | //print version info and credits |

return TRUE; // return TRUE unless you set the focus to a control

}
//-----------------------------------------------------------------------------------------

The program icons were set based on the resources created earlier. The slider control was set to range from 75% to 250% and its initial position was set to 100%. The “Play” button and “File Play” menu item were set to disabled until the user opened a file. Finally, the verbose console was set to disabled by default and version info and credits were printed to the console using the printheader( ) function.

### Example X

This example describes the opening of a music file. The following code was executed when a user clicked the “Open” button:

//-----------------------------------------------------------------------------------------
void CVocoderDlg::OnOpenButton( )
{

char szFilters[ ]= “WAV Files (*.wav)|*.wav|All Files (*.*)|*.*||”;
CFileDialog fileDlg (TRUE, “wav”, “*.wav”, OFN_FILEMUSTEXIST| OFN_HIDEREADONLY, szFilters, this);
if( fileDlg.DoModal ( )==IDOK )
{

pathName = fileDlg.GetPathName( );
CString fileName = fileDlg.GetFileTitle ( );
m_statusbar.SetSel(0,−1);
m_statusbar.ReplaceSel(“File selected: ” + pathName);
GetWavInfo(pathName);

}

}
//-----------------------------------------------------------------------------------------

An “Open File” dialog box was launched with the default file type set to the *.wav extension for waveform audio files. If the dialog was dismissed with the OK button, the path to the selected file was stored in a CString variable and the GetWavInfo( ) function was called to begin parsing the wave data.

### Example XI

This example describes the toggling of the verbose console. The following code was executed when the user toggles the verbose console option:

//-----------------------------------------------------------------------------------------
void CVocoderDlg::OnViewVerboseconsole( )
{

CMenu* mmenu = GetMenu( );
CMenu* submenu = mmenu−>GetSubMenu(1);
if(verbose)
{

verbose = FALSE;
submenu−>CheckMenuItem(ID_VIEW_VERBOSECONSOLE, MF_UNCHECKED | MF_BYCOMMAND);
CRect r;
CPoint p;
GetWindowRect(r);
p = r.TopLeft( );
SetWindowPos(&CWnd::wndTop, p,x,p.y,365,275, SWP_SHOWWINDOW);

}
else
{

verbose = TRUE;
submenu−>CheckMenuItem(ID_VIEW_VERBOSECONSOLE, MF_CHECKED | MF_BYCOMMAND);
CRect r;
CPoint p;
GetWindowRect(r);
p = r.TopLeft( );
SetWindowPos(&CWnd::wndTop, p.x,p.y,590,615, SWP_SHOWWINDOW);

}

}
//-----------------------------------------------------------------------------------------

In the above code, “verbose” was a global variable of type Boolean. Pointers to the “View→Verbose Console” menu item were first obtained, and then separate blocks of code were executed based on whether the option was selected or de-selected. In either case, the menu item was checked or unchecked. The window size and position was then gathered and modified to either exclude the console from view or enlarge the window to show the console.

### Example XII

This example describes the processing of an input wav file. Binary file I/O functions such as fread( ) were used to read in the wave file contents one byte at a time. The file was first checked for appropriate chunk headers as described above and then variables were declared and initialized according to the data in the file. Finally, a summary of the wave format information was printed to the console.

### Example XIII

This example describes beat detection processing. After processing the wave file, the data samples are read into an array of floating point numbers and processed using the beat detection algorithm. Processing is performed on the entire song before playback can begin.

### Example XIV

This example describes phase vocoding. The vocoding algorithm was included as a member function of the CVocoderRunThread class and was called inside of a loop for each beat of the song. The input argument to this function was a single floating point number representing the position of the CSliderCtrl and was used to determine the stretch/shrink factor for the vocoding algorithm.

### Example XV

This example describes the launching of web browsers. The ShellExecute( ) function was used in each event handler member function for controls that required the launching of a web browser. Passing a URL as an argument to ShellExecute( ) caused the system to launch the default internet browser to that particular site.

### Example XVI

This example describes music playback. When a waveform audio file was selected in from the open file dialog box, a new thread was launched from the GUI. This thread immediately began parsing the wave header information to ensure that a valid file had been selected. This background thread then proceeded to execute the beat detection algorithm via a series of subroutines. A data file was written containing the address in the wav file of each beat detected along with other relevant information about the song such as its beats per minute value.

The processing thread returned to an idle state and awaited a message from the main GUI thread indicating that the play button had been pushed. Upon receiving such a message, the processing thread entered a while loop. The while loop continued until either the end of the song was reached or the stop button was pushed.

Within the while loop, a sound buffer was allocated in memory using malloc( ). The samples representing the first beat of the song were read into the sound buffer directly from the source wave file. This information was stored along with the source sample rate and the number of samples read in a data structure for use by the vocoding algorithm. The processing thread then polled the main GUI thread for the location of the slider control to determine the rate at which to stretch or shrink the beat. The vocoding algorithm subroutine was then launched from the processing thread with this value as its input argument. Upon completion, the output samples were written to a temporary wave file and played back using the window MCI multimedia playback Application Program Interface (hereinafter, “API”). Each beat was played asynchronously, so that program execution continued while the sound was playing. As an output beat was played through speakers, the process began to repeat on the next beat. The application, continuing with the while loop, waited for the first file to finish playing before playing the next beat. The waiting mechanism was implemented using the Sleep( ) function and its duration was determined dynamically at run time based on the time it took the CPU to perform the vocoding and the length of the output wave files. This value was tweaked along with the priority of the processing thread through the options dialog of the GUI. Due to variations in processing speed and configuration, the values were fine tuned on each system on which the application was installed to eliminate any skipping during audio playback.

### Example XVII

This example describes the running of the musical system. The following is intended as a guide for the every day user to operating the application. The program can be launched by executing Vocoder.exe, a standalone application for 32-bit Windows environments.

Opening a song: Upon loading the program, the user may select an input audio file using the “Open” button or by selecting “File Open” from the program menu. The Windows sound recorder can be used to create compatible wave files from the user's existing files or their favorite audio CD's. After selecting a song, its format tag is parsed and the beat detection algorithm is executed on it.
Playing a song: Once a song has been opened, the “Play” button and “File→Play” menu item become enabled. The user can simply click either of these controls to begin music playback. The vocoding algorithm is executed on each beat of the music file and played over the system's speakers or headphones.
Changing the user's rate: A user may change their simulated rate of movement by moving the slider control up or down to indicate an increase or decrease in speed, respectively. A change in playback speed should be noted momentarily after changing the slider position.
Additional features: A verbose console containing detailed status reports on program execution may be viewed by checking the menu item: “View→Verbose Console”. Certain timing parameters for the algorithms may be manipulated through the “View→Options” menu item. An about box is available through menu item “Help→About” which contains links to sources used in this project as well as the project homepage. Finally, the “Stop” button and “File→Stop” menu items may be used to stop playback at any time.
Exiting the application: The user may quit the application by clicking on the “Exit” button or on the “File→Exit” menu item. The application can also be dismissed by clicking the standard Windows close icon.

### Example XVIII

This example describes the components of a wave file. Wave files are broken down into “chunks” of a predetermined length. Chunks containing information about the wave file (e.g., format and length) are found at the beginning of the file, while the remainder of the file is a data chunk containing actual audio samples. For example, the following is a hex dump of the first portion of a wave file:

| | | | | | | | | | | | | | | | | | |
|---|---|---|---|---|---|---|---|---|---|---|---|---|---|---|---|---|---|
| 00000000: | 52 | 49 | 46 | 46 | 2B | 24 | 03 | 00 | 57 | 41 | 56 | 45 | 66 | 6D | 74 | 20 | RIFF+$..WAVEfmt |
| 00000010: | 10 | 00 | 00 | 00 | 01 | 00 | 01 | 00 | 22 | 56 | 00 | 00 | 44 | AC | 00 | 00 | ........″V..D−.. |
| 00000020: | 02 | 00 | 10 | 00 | 64 | 61 | 74 | 61 | 00 | 24 | 03 | 00 | 00 | 00 | 00 | 00 | ....data.$...... |
| 00000030: | 00 | 00 | 00 | 00 | 00 | 00 | 00 | 00 | 00 | 00 | 00 | 00 | 00 | 00 | 00 | 00 | ................ |
| 00000040: | 00 | 00 | 00 | 00 | 00 | 00 | 00 | 00 | 00 | 00 | 00 | 00 | 00 | 00 | 00 | 00 | ................ |
| 00000050: | 00 | 00 | 00 | 00 | 00 | 00 | 00 | 00 | 00 | 00 | 00 | 00 | 00 | 00 | 00 | 00 | ................ |
| 00000060: | 00 | 00 | 00 | 00 | 00 | 00 | 00 | 00 | 00 | 00 | 00 | 00 | 00 | 00 | 00 | 00 | ................ |
| 00000070: | 00 | 00 | 00 | 00 | 00 | 00 | 00 | 00 | 00 | 00 | 00 | 00 | 00 | 00 | 00 | 00 | ................ |
| 00000080: | FF | FF | 00 | 00 | FF | FF | FF | FF | FF | FF | FF | FF | FF | FF | FF | FF | ÿÿ..ÿÿÿÿÿÿÿÿÿÿÿÿ |
| 00000090: | FE | FF | FE | FF | FE | FF | FE | FF | FD | FF | FD | FF | FD | FF | FC | FF | bÿbÿbÿbÿýÿýÿýÿüÿ |
| 000000A0: | FC | FF | FD | FF | FB | FF | FC | FF | FB | FF | FA | FF | FB | FF | FB | FF | üÿýÿûÿüÿûÿúÿûÿûÿ |
| 000000B0: | F8 | FF | FA | FF | F8 | FF | F9 | FF | F7 | FF | F8 | FF | F7 | FF | F6 | FF | øÿúÿøÿùÿ÷ÿøÿ÷ÿöÿ |
| 000000C0: | F7 | FF | F5 | FF | F6 | FF | F4 | FF | F4 | FF | F4 | FF | F3 | FF | F1 | FF | ÷ÿõÿöÿôÿôÿôÿóÿñÿ |
| 000000D0: | F5 | FF | EE | FF | F2 | FF | EF | FF | EF | FF | E9 | FF | F2 | FF | E7 | FF | õÿîÿòÿïÿïÿéÿòÿcÿ |
| 000000E0: | EB | FF | EC | FF | E7 | FF | E9 | FF | E7 | FF | E7 | FF | E7 | FF | E1 | FF | ëÿìÿcÿéÿcÿcÿoÿáÿ |
| 000000F0: | E4 | FF | E2 | FF | E4 | FF | DC | FF | DF | FF | E2 | FF | D9 | FF | E0 | FF | äÿâŷäÿÜÿBÿâÿÚÿàÿ |
| 00000100: | DD | FF | D4 | FF | D7 | FF | D8 | FF | D4 | FF | CE | FF | D4 | FF | CE | FF | ÝÿÔÿXÿØÿÔÿÎÿÔÿÎÿ |

Wave files begin with a “RIFF chunk” that contains 12 bytes of data. Bytes 0-3 contain the ASCII values for the word “RIFF” (e.g., 52 49 46 46). The next four bytes contain the length of the chunk. The last 4 bytes contain the ASCII values for the word “WAVE” (e.g., 57 41 56 45). The word RIFF indicates that this is a Microsoft multimedia file. The word WAVE indicates that its data is in the form of waveform audio.

The RIFF chunk of a wave file is immediately followed by a “fmt chunk”. A fmt, or format, chunk contains information about the format of the wave file's data section. The first four bytes of this chunk are the ASCII values of the word “fmt”. The hexadecimal values for this string are 66 6D 74 20. The next four bytes specify the length of the format chunk.

The next two bytes indicate the compression method used on the data. Standard uncompressed PCM data is represented by the digit 1. The following two bytes indicate the number of channels, 0 for mono and 1 for stereo. This is followed by four bytes for the sample rate and four bytes for the bytes per second. Typical values for the sample rate field are, for example, 11025, 22050, and 44100. The bytes-per-second field is computed as the sample rate multiplied by the number of bits per sample. The two bytes following these fields represent the block alignment of the data. A value of 1, for example, indicates 8-bit mono, a value of 2, for example, indicates 8-bit stereo or 16 bit mono, and 4 represents 16-bit stereo. The final 2 bytes of the format chunk contain the number of bits per sample (e.g., 8, 16). Optional chunks may or may not be included.

Additionally, wave files contain a standard “data chunk”. This chunk contains four bytes with the ASCII values of the word “data” (e.g., 64 61 74 61 in hex). The next four bytes contain the length of the data segment (e.g., the length of the audio clip). The remainder of the wave file after this point is the raw audio data. The audio clip shown in the hex dump above has, for example, a leading silence indicated by numerous data bytes of 00 at the beginning of the data chunk.

The systems and devices of the present invention process and handle each of the wave file data fields so as to ensure compatibility and high playback quality. Table 1 summarizes the contents of a wave file.

TABLE 1

| | | FIELD SIZE |
|---|---|---|
| OFFSET (BYTES) | FIELD NAME/CONTENTS | (BYTES) |
| 0-3 | “RIFF” Chunk Header | 4 |
| 4-7 | Size of File | 4 |
| 8-11 | “WAVE” Description Header | 4 |
| 12-15 | “fmt” Chunk Header | 4 |
| 16-19 | Size of Chunk | 4 |
| 20-21 | Encoding Format | 2 |
| 22-23 | Number of Channels | 2 |
| 24-27 | Sample Rate | 4 |
| 28-31 | Bytes/Second | 4 |
| 32-33 | Block Alignment | 2 |
| 34-35 | Bits/Sample | 2 |
| 36-39 | “data” Chunk Header | 4 |
| 40-43 | Size of Data Chunk | 4 |
| 44-EOF | Data Samples | X |

We claim:

1. A device configured to alter the rate of beats per time interval for an audio signal such that said rate matches a user's rate of movement per time interval.

2. The device of claim 1, wherein said audio signal is a musical piece.

3. The device of claim 1, wherein said audio signal is simultaneously represented while altering said rate of beats per time interval.

4. The device of claim 1, wherein said user's rate of movement is measured with a pedometer.

5. The device of claim 4, wherein said pedometer and said device communicate via wireless communication.

6. The device of claim 1, wherein a beat detection algorithm detects the rate of beats per time interval for said audio signal

7. The device of claim 6, wherein said rate of beats per time interval measured with said beat detection algorithm is altered to match said user's rate of movement per time interval with a phase vocoding algorithm.

8. The device of claim 1, wherein said user's rate of movement per time interval fluctuates.

9. The device of claim 1, wherein said time interval is a minute.

10. The device of claim 1, further comprising a graphical user interface configured to display information regarding said audio signal.

11. A system comprising:
an audio signal library comprising a plurality of audio signals, said audio signal library configured for selection of an audio signal;
a beat detection algorithm configured to measure rate of beats per time interval for said audio signal;
a component configured to alter the rate of beats per time interval of said identifiable audio signal so that it matches a user's rate of movement per time interval; and
a device for representing an altered audio signal.

12. The system of claim 11, wherein said audio signal library is a musical piece library.

13. The system of claim 11, wherein said identifiable audio signal is a musical piece.

14. The system of claim 11, wherein said audio signal is simultaneously represented while altering said rate of beats per minute.

15. The system of claim 11, wherein said user's rate of movement is measured with a pedometer.

16. The system of claim 15, wherein said pedometer and said phase vocoding algorithm communicate via wireless communication.

17. The system of claim 11, wherein said user's rate of movement per time interval fluctuates.

18. The system of claim 11, wherein said time interval is a minute.

19. The system of claim 11, further comprising a graphical user interface configured to display information regarding said audio signal.

20. The system of claim 11, wherein at least a part of said system is housed in an exercise apparatus.

21. A method of synchronizing an audio signal with a user's movement, comprising:
a) providing
i) an audio signal;
ii) a device configured to alter the rate of beats per time interval for said audio signal such that said rate matches a user's rate of movement per time interval; and
iii) a movement detector configured to detect a user's rate of movement per time interval; and
b) detecting said user's rate of movement per time interval with said movement detector; and
c) generating an altered audio signal such that said rate of said altered audio signal matches said user's rate of movement per time interval.

22. The method of claim 21, further comprising the step of representing said altered audio signal.

23. The method of claim 21, wherein said audio signal is a musical piece.

24. The method of claim 21, wherein said user's rate of movement is measured with a pedometer.

25. The method of claim 24, wherein said pedometer and said method communicate via wireless communication.

26. The method of claim 21, wherein a beat detection algorithm detects the rate of beats per time interval for said audio signal

27. The method of claim 26, wherein said rate of beats per time interval measured with said beat detection algorithm is altered to match said user's rate of movement per time interval with a phase vocoding algorithm.

28. The method of claim 21, wherein said user's rate of movement per time interval fluctuates.

29. The method of claim 21, wherein said time interval is a minute.

30. The method of claim 21, further comprising a graphical user interface configured to display information regarding said audio signal.

31. A device configured to alter the rate of beats per time interval for an audio signal such that said rate matches a user's rate of movement per time interval, wherein said alteration results in a total harmonic distortion less than 2%.

32. A device configured to alter the playback of musical beats for an audio signal such that said beats match a user's movement, wherein the device comprises a beat detection algorithm that detects each beat in said audio signal and records said beat in a data file.

33. The device of claim 32, wherein said device further comprises a playback algorithm that coordinates said beat with the time of said movement.

34. The device of claim 33, wherein said device further comprises an algorithm that stretches or shrinks audio between said beats so as to provide a smooth transition between said movements.

35. The device of claim 34, wherein said smooth transition avoids skipping or overlapping of said audio between said beats.

36. The device of claim 32, wherein said user's movement is measured with a pedometer.

37. The device of claim 36, wherein said pedometer and said device communicate via wireless communication.

38. The device of claim 32, wherein said device is configured to continuously alter the playback of said musical beats for said audio signal.

39. The device of claim 32, further comprising a graphical user interface configured to display information regarding said audio signal.

40. The device of claim 32, wherein said playback is halted upon the ceasing of said user's movement.

41. A system configured to alter the rate of beats per time interval for an audio signal such that said rate matches a plurality of users' rate of movement per time interval.

42. The system of claim 41, wherein said rate of movement per time interval comprises an average rate of movement of each of said plurality of users.

43. A system configured to select and provide audio to match a predetermined body movement rate to define an exercise interval, said system comprising a processor configured to: a) receive an exercise interval input; b) receive a body movement rate input; c) select an audio file from a library of audio files wherein said selected audio file has a duration that approximates said exercise interval; d) modify the beat of said audio file to match said body movement rate; and e) modify the duration of said audio file, if necessary, to match said interval input.

44. The system of claim 43, wherein said exercise interval comprises a running or walking distance and wherein said body movement rate comprises footstep rate.
